(19) United States
(12) Patent Application Publication
(10) Pub. No.: US 2006/0051481 A1
(43) Pub. Date: Mar. 9, 2006

(54) Pre-portioned dough unit intermediates

(76) Inventors: Andrew C. Kostka, Rogers, MN (US); Tracy K. Vetruba, Buffalo, MN (US); Bruce H. Wisnefske, Montrose, MN (US); Kellie M. Fischer, Coon Rapids, MN (US); Gregory J. Yungner, Champlin, MN (US)

Correspondence Address: GENERAL MILLS, INC., P.O. BOX 1113, MINNEAPOLIS, MN, 55440, US

(21) Appl. No.: 11/199,766

(22) Filed: Aug. 9, 2005

Related U.S. Application Data
(60) Provisional application No. 60/600,297, filed on Aug. 10, 2004.

(51) Int. Cl. A21D 10/00

(52) U.S. Cl. 426/549

(57) ABSTRACT

A non-round, preportioned dough intermediate used to reduce wasted space in shipping materials and to provide increased handling abilities. The non-round, preportioned dough intermediate has at least four sides being connected by at least four non-corner members. When placed in abutting, adjacent relation, a plurality of non-round, preportioned dough intermediates occupies about 80% to about 99.9% of a definable perimeter bounding the plurality of non-round, preportioned dough intermediates. By having less open space, less packaging materials are required and there is reduced opportunity for topical particulates to fall off of the dough intermediates and into unused space.

### PRIORITY CLAIM

The present application claims priority to U.S. Provisional Application Ser. No. 60/600,297 filed Aug. 10, 2004, and entitled “PRE-PORTIONED DOUGH UNIT INTERMEDIATES”, which is herein incorporated by reference in its entirety.

### FIELD OF THE INVENTION

The invention relates generally to forming and packaging dough unit intermediates. More specifically, the invention is directed to a process for continually forming pre-portioned dough unit intermediates requiring minimal packaging while providing for a visually appealing baked product.

### BACKGROUND OF THE INVENTION

Due to the demands and stresses of modern life, many people no longer have the time or desire to create meals or desserts from scratch. Instead, people often purchase ready-to-eat products that are prepared for immediate consumption without further preparation or ready-to-bake products that are prepared so as to go directly from the pantry, refrigerator or freezer to the oven or other associated baking appliance. In addition, commercial bakers frequently make use of ready-to-bake products to save time when preparing the large quantities of baked goods they often prepare on a daily basis.

One ready-to-bake product that continues to gain in popularity is ready-to-bake cookies, for example cookies sold by the Pillsbury division of General Mills, Inc., which can go from a refrigerated or frozen dough state to a freshly prepared, hot cookie in a matter of minutes. The only preparation steps required are to heat the oven, remove the dough intermediate from the packaging, place the dough intermediate on a cooking sheet and place the cooking sheet within the oven. Not only can fresh cookies be prepared in just a few minutes, the individual or commercial baker can be assured that the taste and general appearance will be of a consistent quality without any concern for possible errors from preparation of the dough from scratch.

Ready-to-bake cookie intermediates are currently prepared in one of two ways. First, the cookie intermediates can be individually extruded to form precisely portioned dough pucks. These dough pucks are extruded in a round shape. The round dough pucks are either manually or automatically positioned on a shipping tray and may be stacked on top of each other in a plurality of layers. Due to their round nature, gaps are present between adjacent dough pucks as the edges of each round dough puck are in contact at only point. This empty space represents an added packaging cost. In addition, the empty space provides a point for particulates such as chocolate chips, nuts and other commonly used particulate to fall out of or from the top of the dough pucks.

The second manner used to form ready-to-bake cookie intermediates is to extrude a large sheet of cookie dough, which is then cut or scored to form square cookie products. In this manner, individual cookie intermediates are not consistently portioned there can be significant size deviations from one intermediate to the next. In addition, it may be difficult to separate individual cookie intermediates from the sheet.

While the current methods for forming ready-to-bake cookie intermediates provide for tasty baked cookies, the current methods either require excess packaging materials or may result in inconsistent cookie sizes. As such, it would be advantageous to prepare the ready-to-bake cookie intermediates in a manner that reduces the amount of packaging necessary for a given number of cookie intermediates while providing for a pre-portioned and consistent quality of cookie intermediate.

### SUMMARY OF THE INVENTION

The invention addresses the aforementioned needs by providing a process for individually extruding a preportioned cookie intermediate in a non-round shape. When packaging a plurality of these non-round dough intermediates, a given number of dough intermediates requires less space than the traditional round dough intermediates as non-round dough intermediates adjacent one another are in contact along almost an entire side surface of the non-round intermediate. As there is less open space, there is less space for any particulates to fall between adjacent dough intermediates. The individually extruded non-round dough intermediates provide for a clear delineation between individual dough intermediates such that the individual intermediates can be easily and consistently separated. When the intermediates are aligned in abutted arrangement, the increased contact along adjacent dough intermediates provides rigidity to a dough set allowing the entire dough set to be removed from the packaging and handled as a unit.

In one example embodiment, a plurality of pre-portioned dough intermediates are extruded to form individual non-round dough intermediates. The plurality of non-round dough intermediates can be placed, either manually or automatically, on a packaging carrier. Adjacent dough intermediates are aligned and substantially abutted to form dough sets comprising a plurality of dough intermediates. As adjacent dough intermediates are in contact along the majority of a side, each dough set has a quality of rigidity allowing an entire dough set to be manipulated as a single unit.

In another example embodiment, the invention comprises a non-round dough intermediate.

In another example embodiment, the invention comprises a dough set of aligned and abutted dough intermediates.

In another example embodiment, the invention comprises an extrusion form for forming non-round dough intermediates.

In another example embodiment, the invention comprises a process for extruding non-round dough intermediates.

In another example embodiment, the invention comprises a process for reducing unused packaging space with non-round dough intermediates.

As used throughout the specification and claims, the term “non-corner” refers to a junction between adjacent sides of a dough intermediate, wherein the adjacent sides are joined in a non-perpendicular arrangement.

As used throughout the specification and claims, the term “pre-proportioned” refers to the individual formation of dough intermediates such that the dough intermediates generally comprise the same appearance, shape, volume and size.

As used throughout the specification and claims, the term “intermediate” refers to a dough unit requiring a further processing step such as, for example, cooking with a suitable thermal process prior to consumption by an end user.

The above summary of the various embodiments of the invention is not intended to describe each illustrated embodiment or every implementation of the invention. The figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a top view of a loaded shipping tray having a plurality of pre-portioned, round cookie intermediates of the prior art.

FIG. 2 is a top view of a loaded shipping tray having a sheet of scored, square cookie intermediates of the prior art.

FIG. 3 is a top view of an extruded, pre-portioned cookie intermediate having a non-round shape.

FIG. 4 is a section view of the extruded, pre-portioned cookie intermediate of FIG. 3.

FIG. 5 is a side, view of an extrusion process.

FIG. 6 is a top view of an extrusion form.

FIG. 7 is an end view of the extrusion process of FIG. 5.

FIG. 8 is a top view of a dough set.

FIG. 9 is a top view of a dough set.

FIG. 10 is a side view of layered dough sets.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

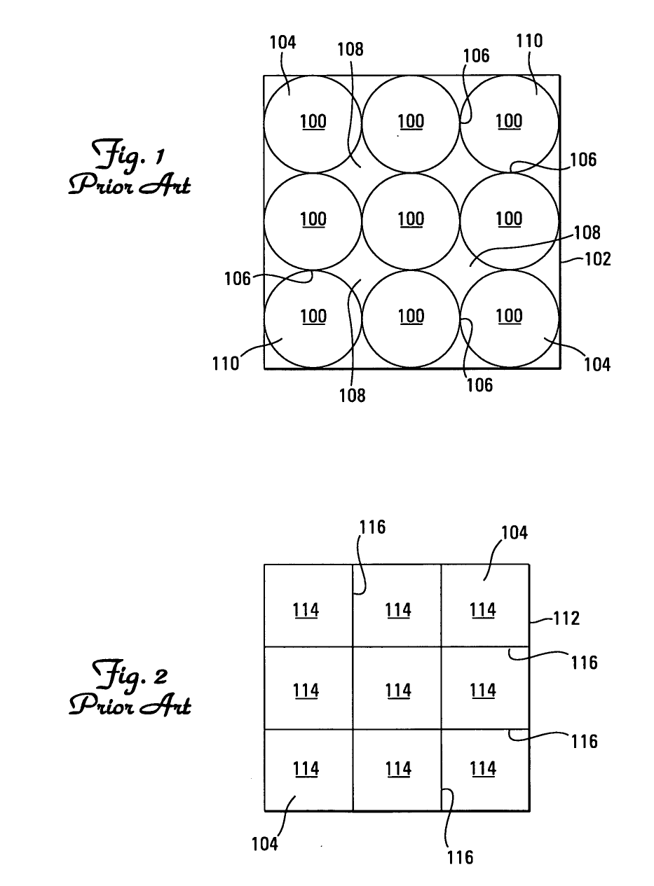

Referring now to FIGS. 1 and 2, prior art formats of packaged cookie dough intermediates are depicted. As shown in FIG. 1, a plurality of generally circular cookie intermediates 100 are arranged in abutted, adjacent relation surrounded by a definable perimeter 102. Circular cookie intermediates 100 can be formed by extruding a cookie dough 104 through a circular die in an extruder. Cookie dough 104 comprises a cookie dough such as sugar cookie dough, oatmeal cookie dough, chocolate chip cookie dough or peanut butter dough. Alternatively, cookie dough 104 can comprise other types of suitable baking dough such as a biscuit dough. By extruding each circular cookie intermediate 100 individually, the circular cookie intermediates 100 can be consistently formed to be the same size, shape and volume. Generally circular cookie intermediates 100 are arranged such that adjacent intermediates touch at a single contact point 106. In some instances, adjacent circular cookie intermediates 100 may have an increased contact surface resulting in shingling which may require a cutting step to separate adjacent cookie intermediates 100 or may result in breakage such that adjacent circular cookie intermediates 100 do no have equivalent sizes, shapes and/or volumes. Between adjacent cookie intermediates 100 is open space 108. Open space 108 represents unused packaging space, which translates into unused and excess packaging materials resulting in extra packaging costs and increased storage size requirements. The plurality of circular cookie intermediates 100 occupy 78.9% of the definable perimeter 102 such that open space 108 represents 21.1% of definable perimeter 102 as illustrated in the Table 1 below.

TABLE 1

| | |
|---|---|
| Assumptions: | Qty. 9 circular cookie intermediates 100 |
| | 3 inch diameter |
| | arranged in 3 × 3 grid |
| | adjacent cookie intermediates in contact at contact |
| | point 106 |
| | Total intermediate area = 63.9 in 2 (7.1 multiplied |
| | by 9) |
| | Definable Perimeter 102 - 81 in² (9 inches × 9 inches) |
| | 63.9/81 = 78.9% of Bounding Area occupied by cookie |
| | intermediate 100 |
| | Open space = 100 − 78.9 = 21.1% |

In addition, circular cookie intermediates 100 may have particulate matter, for example chocolate chips, candies, nuts and the like, on a top surface 110 which can fall off of the circular cookie intermediate 100 and into open space 108.

As shown in FIG. 2, an alternative format for packaging prepared dough intermediates includes an extruded a sheet 112 of cookie dough 104. The sheet 112 is scored to form a plurality of square cookie intermediates 114 that are defined by grooves or scores 116. Scores 116, which may extend at least partially through the sheet 112 are further described in U.S. Pat. No. 6,024,997 to Blaschke et al. The sheet 112 fully occupies 100% of the definable perimeter 102. As shown in FIG. 2, sheet 112 does not allow for any open space between the square cookie intermediates 114. As such, the amount of packaging required for square cookie intermediates 114 is kept at a minimum. Preferably, the cutting member is positioned such that the square cookie intermediates 114 have a consistent size however there is no mechanism by which the cutting member insures that the individual square cookie intermediates 114 are equivalently portioned. In addition, separation of the square cookie intermediates 114 requires a a cutting or breaking step along the scores 116 in order to separate the individual intermediates. Depending upon the positioning of the cutting member and the cutting/breaking of the sheet 112 along the scores 116, there can be a wide size variation in the size, shape and volume of the separated square cookie intermediates 114.

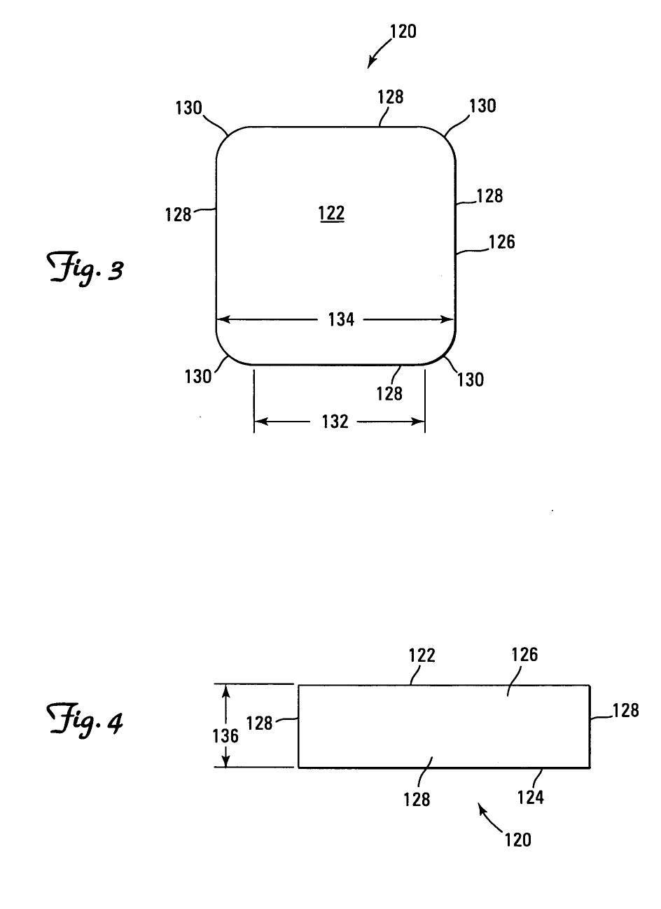

As shown in FIGS. 3 and 4, an embodiment of a non-round cookie intermediate 120 is depicted. Non-round cookie intermediate 120 has a top surface 122, a bottom surface 124 and a perimeter surface 126. Perimeter surface 126 can resemble a rectangular-like or square-like shape and is defined by at least four sides 128. Adjacent sides 128 do not come into perpendicular contact to form corners but instead are joined by four non-corner segments 130. Non-corner segments 130 can comprise any of a variety of non-perpendicular junctions between the adjacent sides 128 such as, for example, arcs or angled lines that extend between and connect adjacent sides 128. Sides 128 have a contact length 132 and are separated from the opposed side by a dough length 134. Dough length 134 generally corresponds to the diameter for the circular cookie intermediate 100 and the side lengths for the square cookie intermediate 114. Typically for cookies, dough length 134 can range from about 0.5 to about 4.0 inches in length. For non-round cookie intermediate 120, a ratio of contact length 132 to dough length 134 can be within a range of about 0.1 to about 0.9. Non-round cookie intermediate 120 also has an intermediate thickness 136 which can range from about 0.25 to about 2.0 inches. Non-round cookie intermediate 120 is preferably dimensioned to form a round cookie product when baked.

As illustrated in FIG. 5, non-round cookie intermediate 120 is formed by an extrusion process utilizing a conventional extruder, for example extruders of the type currently manufactured and sold by APV Baker of Peterborough, United Kingdom or Bepex GMBH of Leingarten, Germany. Cookie dough 104 is fed into an extruder 138 and is forced through an extrusion form 140 to form a continuous dough rope 142. The dough rope 142 is sliced with a cutting member 144 to form the non-round cookie intermediate 120. After the non-round cookie intermediate 120 has been sliced, non-round cookie intermediate 120 can be positioned on a packaging carrier 145 and carried by a conveyor 146 for additional processing, such as refrigerating, freezing and packaging. By extruding and slicing each non-round cookie intermediate 120, each non-round cookie intermediate 120 is pre-portioned and has the same size, shape and volume.

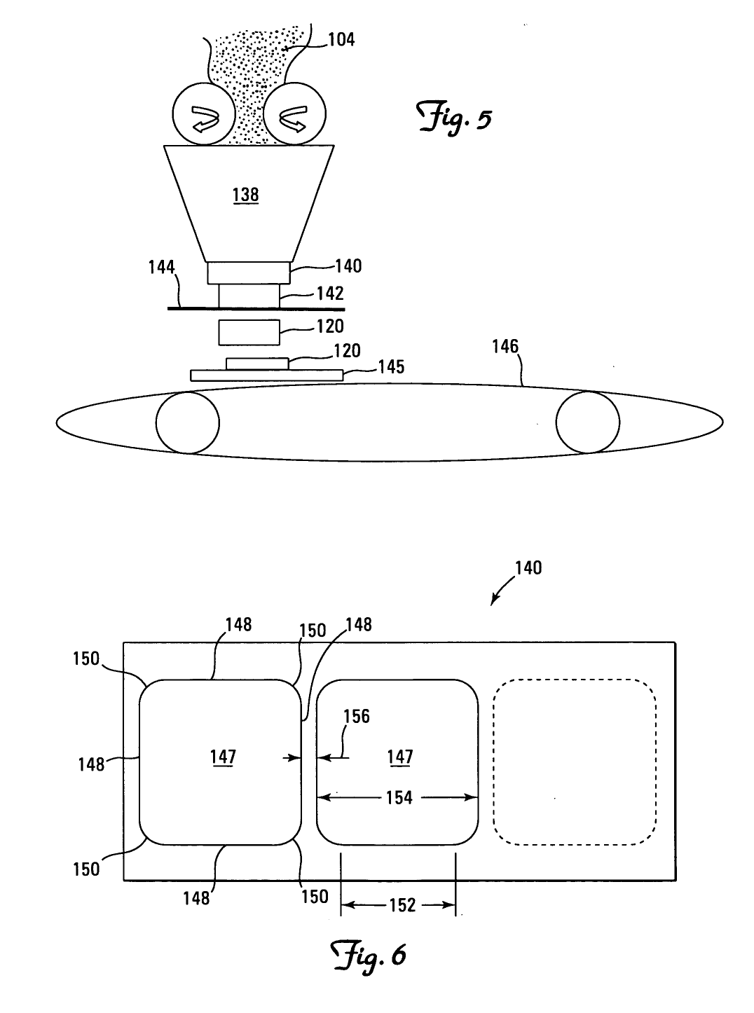

As shown in FIG. 6, extrusion form 140 has at least one non-circular aperture 147 and may include multiple apertures 147 depending upon desired capacity. Non-circular aperture 147 resembles the non-round cookie intermediate 120 and is defined by at least four sides 148. Adjacent sides 148 do not come into perpendicular contact but are instead joined by at least four non-corner aperture segments 150. The non-corner aperture segments 150 can comprise any of a variety of non-perpendicular junctions between the adjacent sides 148 such as, for example, arcs or angled sides that extend between and connect adjacent sides 148. Sides 148 have a side length 152. Opposed sides 148 are separated by a separation length 154. To form non-round cookie intermediate 120, a ratio of side length 152 to separation length 154 can be at a range of about 0.1 to about 0.9. When extrusion form 140 includes a plurality of apertures 147, the apertures 147 are separated by an aperture separation distance 156 which ranges from about 0.01 inches to about 0.25 inches.

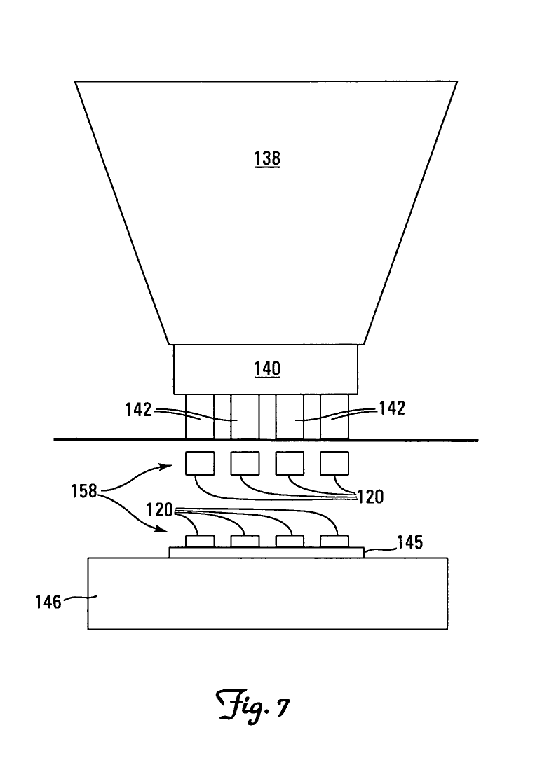

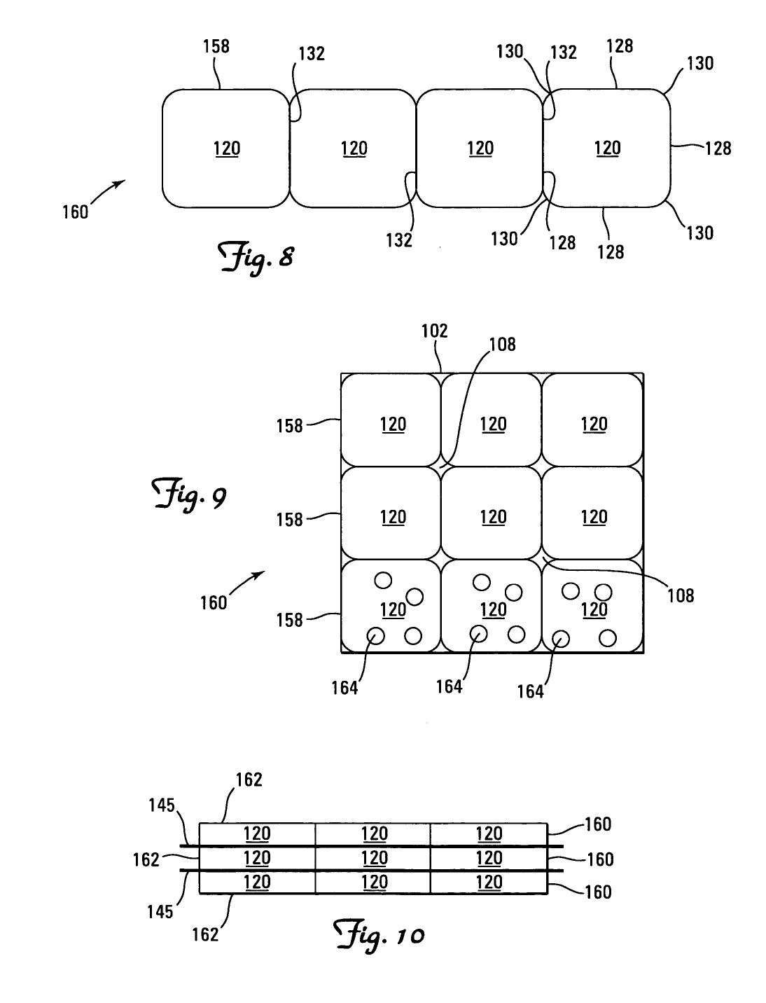

When the extrusion form 140 includes multiple apertures 147, a row 158 of non-round cookie intermediates 120 can be simultaneously extruded and positioned on the conveyor 146 as shown in FIG. 7. Initially, the non-round cookie intermediates 120 are spaced apart by the aperture separation distance 156. The conveyor 146 is then lifted causing sides 128 of adjacent non-round cookie intermediates 120 to abut one another along the contact length 132 to create a dough set 160 as shown in FIG. 8. Because of the contact along contact length 132 of adjacent non-round cookie intermediates 120, dough set 160 is imparted with a level of rigidity allowing the dough set 160 to be manipulated, such as lifted or placed, as a single unit. Rigidity can be further imparted to the dough set 160 by freezing the dough set 160. As shown in FIGS. 9 and 10, the dough set 160 can incorporate a plurality of rows 158 and may be stacked in a plurality of layers 162.

As shown in FIG. 9, the dough set 160 resides within the definable perimeter 102. Due to increased contact between non-round cookie intermediates 120 along contact length 132, total open space 108 is significantly reduced as compared to the circular cookie intermediates 100 as shown in FIG. 1. When the ratio of contact length 132 over dough length 134 is maintained within a range of about 0.1 to about 0.9, dough set 160 can occupy from about 80% to about 99.9% of the definable perimeter 102. Correspondingly, open space 108 is reduced to from about 0.1% to about 20% of the definable perimeter 102. By reducing open space 108, less unused space is used in packaging materials resulting in lower packaging costs and smaller storage sizes. In addition, reducing the open space 108 reduces the potential for or incidence of particulates 164 such as chocolate chips, candy, nuts and the like from falling out of the cookie dough 104 or off the top surface 122 and into the open space 108. By having more particulates 164 on the top surface 122, the non-round cookie intermediate 120 is more visually appealing and prevents wasting particulates 164. Dough set 160 retains the advantages associated with proportioned cookie intermediates as opposed to the square cookie intermediates 114 as dough set 160 is easily separable into the individual non-round cookie intermediates 120 which will have a consistent size, shape and appearance when baked.

Although various embodiments of the invention have been disclosed here for purposes of illustration, it should be understood that a variety of changes, modifications and substitutions may be incorporated without departing from either the spirit or scope of the invention.

What is claimed:

1. A dough intermediate comprising:
a preportioned amount of dough having a non-round perimeter, the non-round perimeter defined by at least four sides wherein adjacent sides are connected by a non-corner segment, the dough having a dough length dimensioned between two opposed sides, and each side having a contact length dimensioned between non-corner segments at the end of each side wherein a ratio of the contact length to the dough length is about 0.1 to about 0.9.

2. The dough intermediate of claim 1, wherein the proportioned amount of dough comprises a cookie dough.

3. The dough intermediate of claim 1, wherein the side distance is about 0.5 inches to about 4.0 inches.

4. The dough intermediate of claim 1, wherein the non-round orientation is further defined by a dough thickness of about 0.25 to about 2.0 inches thick.

5. The dough intermediate of claim 1, wherein the preportioned amount of dough has a weight of about 7 to about 200 grams.

6. A dough set comprising:
a plurality of a pre-portioned dough intermediates positioned in an abutted, adjacent arrangement defining at least one row of dough intermediates wherein said at least one row of dough intermediates is contained within a definable perimeter and wherein the plurality of dough intermediates covers about 80% to about 99.9% of the definable perimeter.

7. The dough set of claim 6, wherein the plurality of pre-portioned dough intermediates are arranged to define a plurality of rows of pre-portioned dough intermediates.

8. The dough set of claim 6, wherein the pre-portioned dough intermediates are formed of a cookie dough selected from a peanut butter dough, an oatmeal dough and a chocolate chip dough.

9. The dough set of claim 6, wherein the at least one row of dough intermediates can be manipulated as a single unit.

10. The dough set of claim 6, wherein the plurality of pre-portioned dough intermediates are positioned in an abutted, adjacent arrangement by placing adjacent sides of adjacent pre-portioned dough intermediates into abutted relation.

11. An extrusion form comprising:
a form body having at least one non-round aperture, the non-round aperture defined by at least four sides wherein adjacent sides are connected by a non-corner segment, the aperture having a separate length dimensioned between opposed sides, and each side having a side length dimensioned between non-corner segments at the end of each side wherein a ration of the side length to the separation length is about 0.1 to about 0.9.

12. The extrusion form of claim 11, wherein the form body comprises a plurality of non-round apertures.

13. The extrusion form of claim 12, wherein each non-round aperture is separated by an aperture spacing distance of about 0.01 inches to about 0.25 inches.

14. The extrusion form of claim 11, wherein the at least four non-corner segments are arc-shaped.

15. A process for extruding a non-round dough intermediate comprising:
extruding a baking dough through an extrusion form to form a continuous dough rope, a extrusion form having at least one non-round aperture, the non-round aperture defined by at least four sides wherein adjacent sides are connected by a non-corner segment, the aperture having a separate length dimensioned between opposed sides, and each side having a side length dimensioned between non-corner segments at the end of each side wherein a ration of the side length to the separation length is about 0.1 to about 0.9; and
slicing the continuous dough rope to form a preportioned, non-round dough intermediate.

16. The process of claim 15, wherein the extrusion form has a plurality of non-round apertures such that a plurality of continuous dough ropes are simultaneously formed.

17. The process of claim 16, wherein the plurality of continuous dough ropes are sliced to form a plurality of preportioned, non-round dough intermediates.

18. The process of claim 17, further comprising:
positioning the plurality of portioned, non-round dough intermediates in an abutted fashion such that a row of dough intermediates is formed.

19. The process of claim 18, further comprising:
freezing the row of dough intermediates to form a rigid row of dough intermediates capable of being manipulated as a single unit.

20. A process for reducing the shipping volume of a dough set comprising:
extruding a baking dough through an extrusion form, the extrusion form having a plurality of non-round apertures, the baking dough forming a plurality of continuous dough ropes;
slicing each dough rope to form a plurality of preportioned, non-round dough intermediates
positioning the plurality of preportioned, non-round dough intermediates in an abutted, adjacent arrangement defining at least one row of dough intermediates wherein said at least one row of dough intermediates is contained within a definable perimeter and wherein the plurality of dough intermediates covers about 80% to about 99.9% of the definable perimeter.
